(19) United States
(12) Patent Application Publication
(10) Pub. No.: US 2022/0156666 A1
(43) Pub. Date: May 19, 2022

(54) SYSTEMS AND METHODS FOR CONFIDENCE INTERVAL TRANSACTION SETTLEMENT RANGE PREDICTIONS

(71) Applicant: Fidelity Information Services, LLC, Jacksonville, FL (US)

(72) Inventors: Daniel Tantum, Manalapan, NJ (US); Minming Ding, Morganville, NJ (US); Ying Ji, West Windsor, NJ (US); Xiaodan Pan, Marlboro, NJ (US); Sean Daley, Pittsburgh, PA (US); Andrew Scharhag, Jacksonville, FL (US); Matthew Pond, Newbury Park, CA (US); Michael Shields, Rockaway, NJ (US)

(73) Assignee: Fidelity Information Services, LLC, Jacksonville, FL (US)

(21) Appl. No.: 16/952,713

(22) Filed: Nov. 19, 2020

(51) Int. Cl. G06Q 10/06; G06Q 40/00; G06Q 30/02; G06Q 40/08; G06Q 10/10; G06Q 40/02; G06N 20/00; G06F 9/54

(52) U.S. Cl. CPC G06Q 10/06375; G06Q 40/12; G06Q 30/0202; G06F 9/541; G06Q 10/109; G06Q 40/025; G06N 20/00; G06Q 40/08

(57) ABSTRACT

Methods and systems include receiving invoice data associated with an open invoice under an account; determining an expected payment date for the open invoice by inputting the data to a prediction model derived from a machine learning technique; determining an expected payment date range under a confidence level for the open invoice based on the invoice data and the open invoice; determining a probability of receiving a payment for the open invoice by a predetermined date; and outputting the expected payment date, the expected payment date range under the confidence level, and the probability of receiving the payment for the open invoice by the predetermined date for risk management analysis.

### TECHNICAL FIELD

The present disclosure generally relates to computerized methods and systems for predicting transaction settlement ranges and, more particularly, to computerized methods and systems for forecasting date ranges for invoice payments using intervals estimations.

### BACKGROUND

One of the largest assets for companies is their accounts receivable. Accounts receivable are essential for a company to operate and improving predictability through technology providing additional intelligence regarding when to expect complete payment translates to increased productivity. One important aspect of collection and treasury management is to efficiently and effectively collect accounts receivable and deduce cashflow information therefrom, such as when and how much payments will occur. The efficiency and effectiveness of collecting accounts receivable rely on accurate predictions of invoice payments, including expected payment dates and expected payment date ranges. Based on such predictions, companies may allocate their limited resources to collect payments and lower the risk of business operations, and treasurers of the companies may have greater confidence in timely collecting the accounts receivable and better vision in the collection amount and timing, better equipping them for their cash management responsibilities.

One technical problem encountered with this type of collection and treasury management stems from existing systems' inability to predict invoice payments with high accuracy because the existing systems may be unable to effectively or efficiently extract information from historical data of past transactions. As such, existing solutions are lacking in functionality to provide companies with the ability to efficiently collect accounts receivable or otherwise provide companies with a clear vision of their cashflow from account receivables. Disclosed embodiments address these and other technical challenges to existing systems that cause wasted resources in business operations and increased risks in cash management.

### SUMMARY

One aspect of the present disclosure is directed to a system. The system includes a non-transitory computer-readable medium configured to store instructions and at least one processor configured to execute the instructions to perform operations. The operations include receiving invoice data associated with an open invoice under an account, the invoice data including at least one of an amount of a past invoice under the account, an open date of the past invoice, or a payment date of the past invoice, and at least one of a count of closed invoices under the account, an average days to pay of the closed invoices, a count of overdue invoices under the account, or an average overdue days of the overdue invoices; determining an expected payment date for the open invoice by inputting the invoice data to a prediction model derived from a machine learning technique; determining an expected payment date range under a confidence level for the open invoice based on the invoice data and the open invoice, the confidence level being a statistical estimate representing a probability that an actual payment date falls in the expected payment date range; determining a probability of receiving a payment for the open invoice by a predetermined date; and outputting the expected payment date, the expected payment date range under the confidence level, and the probability of receiving the payment for the open invoice by the predetermined date for risk management analysis.

Other aspects of the present disclosure are directed to computer-implemented methods for performing the functions of the systems discussed above.

Other systems, methods, and computer-readable media are also discussed herein.

### BRIEF DESCRIPTION OF THE DRAWINGS

FIG. 1 is a block diagram of an example server computer system for confidence interval transaction settlement range predictions, consistent with the disclosed embodiments.

FIG. 2 is a flowchart of an example process for confidence interval transaction settlement range predictions in the system shown in FIG. 1, consistent with the disclosed embodiments.

### DETAILED DESCRIPTION

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

The disclosed embodiments include systems and methods for confidence interval transaction settlement range predictions. Before explaining certain embodiments of the disclosure in detail, it is to be understood that the disclosure is not limited in its application to the details of construction and to the arrangements of the components set forth in the following description or illustrated in the drawings. The disclosure envisions embodiments in addition to those explicitly described capable of being practiced and carried out in various ways. Also, it is to be understood that the phraseology and terminology employed herein, as well as in the accompanying drawings, are for the purpose of description and should not be regarded as limiting.

Reference will now be made in detail to the present example embodiments of the disclosure, examples of which are illustrated in the accompanying drawings. Wherever possible, the same reference numbers will be used throughout the drawings to refer to the same or like parts.

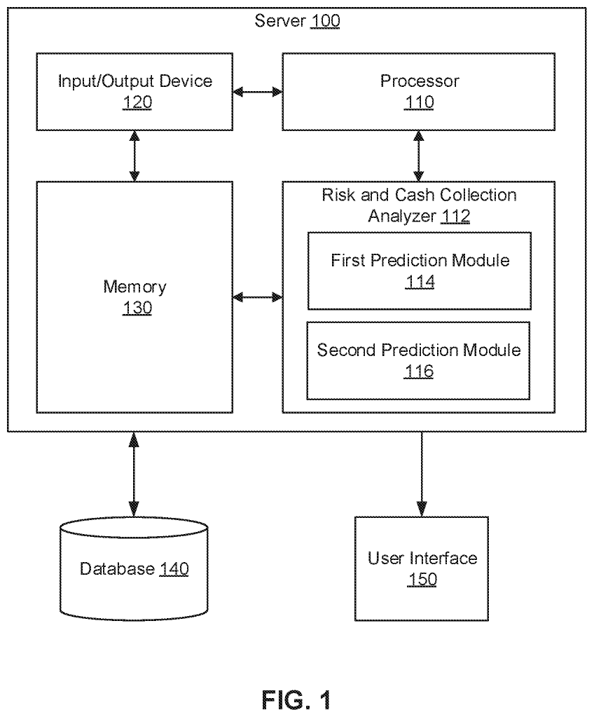

FIG. 1 is a block diagram of an example server computer system 100 (referred to as “server 100” hereinafter), consistent with the disclosed embodiments. Server 100 may be one or more computing devices configured to execute software instructions stored in memory to perform one or more processes consistent with the disclosed embodiments. For example, server 100 may include one or more memory devices for storing data and software instructions and one or more hardware processors to analyze the data and execute the software instructions to perform server-based functions and operations (e.g., back-end processes). The server-based functions and operations may be confidence interval transaction settlement range predictions.

In FIG. 1, server 100 includes a hardware processor 110, an input/output (I/O) device 120, and a memory 130. It should be noted that server 100 may include any number of those components and may further include any number of any other components. Server 100 may be standalone, or it may be part of a subsystem, which may be part of a larger system. For example, server 100 may represent distributed servers that are remotely located and communicate over a network.

Processor 110 may include or one or more known processing devices, such as, for example, a microprocessor. In some embodiments, processor 110 may include any type of single or multi-core processor, mobile device microcontroller, central processing unit, etc. In operation, processor 110 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in memory 130, processor 110, or elsewhere.

I/O device 120 may be one or more devices configured to allow data to be received and/or transmitted by server 100. I/O device 120 may include one or more customer I/O devices and/or components, such as those associated with a keyboard, mouse, touchscreen, display, etc. I/O device 120 may also include one or more digital and/or analog communication devices that allow server 100 to communicate with other machines and devices, such as other components of server 100. I/O device 120 may also include interface hardware configured to receive input information and/or display or otherwise provide output information. For example, I/O device 120 may include a monitor configured to display a customer interface.

Memory 130 may include one or more storage devices configured to store instructions used by processor 110 to perform functions related to disclosed embodiments. For example, memory 130 may be configured with one or more software instructions associated with programs and/or data.

Memory 130 may include a single program that performs the functions of the server 100, or multiple programs. Additionally, processor 110 may execute one or more programs located remotely from server 100. Memory 130 may also store data that may reflect any type of information in any format that the system may use to perform operations consistent with disclosed embodiments. Memory 130 may be a volatile or non-volatile (e.g., ROM, RAM, PROM, EPROM, EEPROM, flash memory, etc.), magnetic, semiconductor, tape, optical, removable, non-removable, or another type of storage device or tangible (i.e., non-transitory) computer-readable medium.

Server 100 may be communicatively connected to one or more databases 140. For example, server 100 may be communicatively connected to database 140. Database 140 may be a database implemented in a computer system (e.g., a database server computer). Database 140 may include one or more memory devices that store information (e.g., one or more recordings of verbal communications) and are accessed and/or managed through server 100. By way of example, database 140 may include Oracle™ databases, Sybase™ databases, or other relational databases or non-relational databases, such as Hadoop sequence files, HBase, or Cassandra. Systems and methods of disclosed embodiments, however, are not limited to separate databases. In one aspect, server 100 may include database 140. Alternatively, database 140 may be located remotely from the server 100. Database 140 may include computing components (e.g., database management system, database server, etc.) configured to receive and process requests for data stored in memory devices of database 140 and to provide data from database 140.

Consistent with the disclosed embodiments, server 100 includes a risk and cash collection analyzer 112 that may include a first prediction module 114 and a second prediction module 116. Risk and cash collection analyzer 112 may be configured to communicate with (e.g., by sending data to or receiving data from) an external computer system (not shown in FIG. 1) or database 140 to retrieve data or store data. In some embodiments, risk and cash collection analyzer 112 may also be configured to output data to another module (e.g., a computer program service, not shown in FIG. 1) for risk or treasury management analysis. Risk and cash collection analyzer 112 may be implemented as software (e.g., program codes stored in memory 130), hardware (e.g., a specialized chip incorporated in or in communication with processor 110), or a combination of both.

First prediction module 114 may be configured to analyze data and predict a first type of prediction (e.g., an expected payment date). In some embodiments, first prediction module 114 may retrieve the data needed for performing such a prediction from database 140, the I/O device 120, or both. Second prediction module 116 may be configured to analyze data and predict a second type of prediction (e.g., an expected date range with a probability predicting receiving payments within the expected date range, a probability to pay by a predetermined date for an open invoice, or a total expected payment amount over a chosen group of open invoices by a predetermined date). In some embodiments, second prediction module 116 may retrieve the data needed for performing such a prediction from database 140, the I/O device 120, or both. In some embodiments, first prediction module 114 and/or a second prediction module 116 may be organized or arranged separately from risk and cash collection analyzer 112. In further embodiments, first prediction module 114 and second prediction module 116 may be combined into one module serving the functions of both modules.

Server 100 may also be communicatively connected to one or more user interface(s) 150. User interface 150 may include a graphical interface (e.g., a display panel), an audio interface (e.g., a speaker), and/or a haptic interface (e.g., a vibration motor). For example, the display panel may include a liquid crystal display (LCD), a light-emitting diode (LED), a plasma display, a projection, or any other type of display. The audio interface may include microphones, speakers, and/or audio input/outputs (e.g., headphone jacks). In some embodiments, user interface 150 may be included in server 100. In some embodiments, user interface 150 may be included in a separate computer system. User interface 150 may be configured to display data transmitted from server 100.

In connection with server 100 as shown and described in FIG. 1, aspects of this disclosure may provide a technical solution to technical problems in confidence interval transaction settlement range predictions, including systems, apparatuses, methods, and non-transitory computer-readable media. For ease of description, a system is described below, with the understanding that aspects to the system apply equally to apparatuses, methods, and non-transitory computer-readable media. The system may include a non-transitory computer-readable medium configured to store instructions and at least one processor configured to execute the instructions to perform operations. For example, some aspects of such a system (e.g., server 100 and database 140) may implement the operations. The operations may also be implemented by an apparatus (e.g., server 100), or as program codes or computer instructions stored in a non-transitory computer-readable medium (e.g., memory 130 or another storage device of server 100). In a broadest sense, the operations are not limited to any particular physical or electronic instrumentalities, but rather can be accomplished using many different instrumentalities.

Consistent with some embodiments of this disclosure, the processor of the system may receive invoice data associated with an open invoice under an account. The invoice data, as used herein, may include at least one of an amount of a current or past invoice under the account, an open date of the current or past invoice, or a payment date of the current or past invoice. Indeed, the invoice data may include any type of data associated with the account, such as data associated with other current or past invoices (paid, unpaid, partially paid, or generated when the account first opened with the payee) of the account. The invoice data may also include at least one of a count of closed invoices under the account, an average days to pay of the closed invoices, a count of overdue invoices under the account, or an average overdue days of the overdue invoices. Receiving data, as used herein, may refer to accepting, taking in, admitting, gaining, acquiring, retrieving, obtaining, reading, accessing, collecting, or any operation for inputting the data. An open invoice may include a pending (e.g., unpaid or partially paid) invoice pending for payment that is not overdue. An open date for an invoice may refer to the date when the invoice is generated. A past invoice may include an invoice having an open date prior to the open date of the open invoice. The payment date of an invoice may refer to a date when the invoice is fully paid, and a closed invoice may refer to invoices fully paid in time (i.e., not overdue), either in a lumpsum or in installments. The “average days to pay” of invoices may refer to an average of the days between the open dates of the invoices and the respective payment dates of the invoices. Overdue invoices, on the other hand, may include invoices not fully paid, or entirely unpaid, before their due dates. The “average overdue days” of overdue invoices may refer to an average of the days between the due dates of the overdue invoices and the respective payment dates of the overdue invoices.

In some embodiments, the invoice data may further include a count of pending invoices in a past period (e.g., past 6 months, past year, or any time period before a date of observation) under the account, a count of past payments to the account, and a count of disputed invoices under the account. The “count,” as used herein, may refer to a tally or a number of occurrences. A pending invoice may include an unpaid, partially paid, or otherwise under-paid invoice. Past payments may include any past payment to the account regardless of whether the payment was made in full or as a partial payment of the corresponding invoice(s). Disputed invoices may include any invoice that involve a resolved dispute or is under an unresolved dispute.

Consistent with some embodiments of this disclosure, the processor of the system may also determine an expected payment date for the open invoice by inputting the invoice data to a prediction model derived from a machine learning technique. An expected payment date of an invoice may refer to a predicted date (e.g., carrying a probability) that a payment may be received for the invoice. A machine learning technique may be applied to derive an algorithm, a mathematical model, or computerized procedures that enables a system to automatically learn and improve from training data (e.g., data used for adapting the algorithm towards more accurate performances). In some embodiments, the machine learning technique may include at least one of a generalized least squares regression technique, an ordinary least squares regression technique, a random forest regression technique, a gradient boosting regression technique, or a support vector machine regression technique. In some embodiments, the processor may determine a number of days with a given confidence level, relative to a date of observation or a date of choice, by which a payment is expected to be received for the invoice, or a day range with a given confidence level, relative to a date of observing or a date of choice, between which a payment is expected to be received for the invoice. The “date of observation” in this disclosure may refer to a date (e.g., a “current date” or “today”) when the determination is being made. Such number of days or day range may be converted to an expected payment date or a date range with the given confidence level. In this disclosure, “days” and “dates” are synonymous and may be used interchangeably, because days can be converted to dates (or vice versa), relative to a date of observation or a chosen date of analysis.

A machine learning technique may be used to derive one or more computerized algorithms or computerized models that receive input data (e.g., the invoice data) and automatically output a predictive result (e.g., the expected payment date). The computerized algorithms or computerized models may be built on statistical theories. In some embodiments, the machine learning technique may include at least one of a generalized least squares regression technique, an ordinary least squares regression technique, a random forest regression technique, a gradient boosting regression technique, or a support vector machine regression technique.

Consistent with some embodiments of this disclosure, the processor of the system may further determine an expected payment date range under a confidence level for the open invoice based on the invoice data and the open invoice. The confidence level may be a statistical estimate representing a probability that an actual payment date falls in the expected payment date range. The expected payment date range of an invoice, as used herein, may include a predicted range (e.g., carrying a probability) of payment dates between which a payment may be received for the invoice. For example, the expected payment date range may include a soonest date and a latest date on which the payment may be received for the invoice. The confidence level, as used herein, may refer to a type of statistic estimate that represents a probability that a true value of an unknown parameter (e.g., a mean, a variance, or any statistic datum) falls in a predicted range for plausible values of the unknown parameter. The confidence level may determine the span of the predicted range (also referred to as “confidence interval”). Generally, the higher the confidence level is, the narrower the predicted date range may be.

In some embodiments, the invoice data associated with the open invoice(s) may include one or more observations of past activities of the account. The observations may be deemed as statistical samples. For example, each observation may include information or data related to current or past invoice(s). Each observation may include one or more data elements, such as the amount of the current or past invoice(s) under the account, the open or close date of the current or past invoice(s), the payment date of the current or past invoice(s), the count of the closed invoice(s) under the account(s), the average days to pay of the closed invoice(s), the count of the overdue invoice(s) under the account, the average overdue days of the overdue invoice(s), the count of the pending invoice(s) in the past period under the account, the count of the past payments to the account, the count of the disputed invoice(s) under the account, or any other data element related to the tenure, demographics, financial standing of the account or payment activities of the account.

In some embodiments, the relationship between the actual payment date D and the expected payment date D̅ under the confidence level may be represented as Eq. (1):

D̅−c_{α}·S≤D≤D̅+c_{α}·S Eq. (1)

In Eq. (1), c_{α} represents a critical value that conforms to one tail of a probability distribution c (e.g., a normal distribution or a t-distribution) under a distribution probability a (e.g., 3%, 5%, 10%, or any numerical percentage value), and S represents an estimated forecast error. In accordance with Eq. (1), the expected payment date range may be [D̅−c_{α}·S,D̅+c_{α}·S] under the confidential level α. For example, if α is 5%, the probability distribution c is the t distribution, and c_{α} is a two-tailed critical value of the t distribution, then D may fall within [D̅−c_{0.05}·S,D̅+c_{0.05}·S] with a 90% confidence level.

In some embodiments, the processor may determine the expected payment date range based on the confidence level. For example, if the confidential level is 90%, the probability distribution c is the t distribution, and c_{α} is a two-tailed critical value of the t distribution, then α may be determined as 5%, and the expected payment date range may be determined as [D̅−c_{0.05}·S,D̅+c_{0.05}·S]. In another example, if the confidential level is 95%, the probability distribution c is the normal distribution, and c_{α} is a two-tailed critical value of the normal distribution, then α may be determined as 2.5%, and the expected payment date range may be determined as [D̅−c_{0.025}·S,D̅+c_{0.025}·S]. In some embodiments, when the number of the observations utilized by the machine learning technique to create the algorithm that produces D are small (e.g., below 1000), the probability distribution c may be selected as the t distribution. In some embodiments, when the number of the observations utilized to develop the underlying algorithm that generates D̅ are large (e.g., 1000 or more), the probability distribution c may be selected as the normal distribution.

In some embodiments, the estimated error S may be determined based on Eq. (2):

$$S = \sqrt{[ \frac{1}{n - k} \cdot {Σ ( {D}_{n} - \overline{{D}_{n}} )}^{2} ] \cdot [ 1 + x \cdot {( {X}^{T} \cdot X )}^{- 1} \cdot {x}^{T} ]} \qquad Eq . ( 2 )$$

In Eq. (2), Dₙ represents the actual value of D of each observation n in the historical training data, D̅ₙ̅ represents the expected value of Dₙ of each observation n in the historical training data, and n represents the number of observations in the historical training data. For example, Dₙ may represent the actual days to pay (e.g., days between the invoice open date and the payment date). Also, assuming a t probability distribution associated with c, n−k represents the degrees of freedom that would determine, in combination with the confidence level chosen, the critical value, c_{α}. For example, in Eq. (2), k may be equal to one (the one being assigned to represent a degree of freedom for a regression intercept) plus a total count of data elements uncovered to be included in an algorithm derived from the machine learning technique, using all the observations included in the historical training data.

Further, in Eq. (2), x represents a 1×k vector, and x^{T} may represent a transpose of x. In some embodiments, x may be constructed as starting with number “1” and continue with the values of the data elements uncovered to be included in an algorithm derived from the machine learning technique. Moreover, in Eq. (2), X represents a n×k matrix, X^{T} represents a transpose of X, and (X^{T}·X)⁻¹ represents an inverse of X^{T}·X. In some embodiments, each row of X may represent an observation, and each column of the row may represent a value of a data element of the observation (except that the first column is always a number “1”). Based on the above definitions, x·(X^{T}X)⁻¹·x^{T} will generate a scalar number in accordance with the rules of matrix and vector multiplications.

As can be seen from Eq. (2), k may be a large number. To maintain validity of Eq. (2), n must be greater than k. In some cases, n may be greater than or equal to 1000. Also, Eq. (2) also shows that the expected payment date range may be determined based on both the historical training data (e.g., Dₙ and X) and values of the algorithm's data elements for the open invoice (e.g., x).

Consistent with some embodiments of this disclosure, the processor of the system may further determine the probability of receiving a payment for the open invoice by a predetermined date. The payment of an invoice, as used herein, may refer to the amount predicted to be received for the invoice. The predetermined date, as used herein, may include any date forward from the date of observation as of the date of observation and predetermined by the payee of the invoice. For example, the predetermined date may be set as a date after the current date but before a due date, the due date, a date after the due date, or any date for a predetermined length of time (e.g., 30 days, 60 days, or any length of days).

Consistent with some embodiments of this disclosure, the processor of the system may further output the expected payment date, the expected payment date range under the confidence level, and the probability or receiving the payment for the open invoice by the predetermined date for risk management analysis. The risk management analysis, as used herein, may refer to analysis of data, information, or results for evaluating and managing collections or cashflow risks involved in business operations (e.g., a risk of delinquent payments or a risk of cashflow shortage). For example, based on analysis of the outputted expected payment dates of one or more invoices and the expected payment amount of the one or more invoices by a predetermined date, a finance officer of a business may determine the cashflow before the predetermined date and form corresponding financial decisions (e.g., whether to borrow working capital). As another example, the processor may output the expected payment date, the expected payment date range, and the probability of payment by the predetermined date to a user interface for visualization of the collection risk management analysis. By way of example, the user interface may be user interface 150 in FIG. 1.

In some embodiments, the processor of the system may output the expected payment date, the expected payment date range under the confidence level, the probability of receiving the payment for the open invoice by the predetermined date as a byte stream, and may send the byte stream into an application programming interface (API) for risk management analysis. The byte stream, as used herein, may refer to an ordered sequence of bytes or bits. The API, as used herein, may include a software interface used to exchange data or instructions between multiple software programs or intermediaries. In some embodiments, the byte stream may be a byte stream of a Python® script, and the API may be associated with a backend server-run service (e.g., a cloud service or a Software-as-a-Service service).

In some embodiments, the processor of the system may determine a risk value of the open invoice based on the expected payment date, the expected payment date range under the confidence level, and the probability of receiving the payment for the open invoice by the predetermined date, and may output a recommended action when the risk value is above a threshold value. For example, the risk value may be a numerical value that is positively correlated (e.g., proportional) to a risk level of the open invoice. In some embodiments, the risk value may be determined in accordance with a mapping relationship. In an example, if the expected payment date is within a first time period from a date of observation, the expected payment date range is shorter than a first threshold range, and the probability of receiving the payment by the upper bound of the first time period is higher than a first threshold probability value, then the processor may determine the risk value as a first mapped value. Depending on different values of the expected payment date, the expected payment date range, and the probability of receiving the payment by the upper bound of the first time period, the risk value may have different mapped values. It should be noted that the processor may determine the risk values in various manners, and this disclosure does not limit such manners to the examples described herein.

In some embodiments, the recommended action may include at least one of sending a reminder (e.g., an email, a text, a phone call, or a mobile application notification) to a holder of the account (e.g., an owner, an agent of the owner, an authorized user, an account administrator, or any individual or entity associated with operating an account) before the predetermined date, sending a notification (e.g., an email, a text, a phone call, or a mobile application notification) recommending a payment plan to the holder of the account before the predetermined date, sending a warning notification (e.g., an email, a text, a phone call, or a mobile application notification) to the holder of the account when the open invoice is not yet or marginally (e.g., within a preset number of days, such as five days) overdue, or sending the open invoice to a debt collection agency when the open invoice is significantly (e.g., beyond the preset number of days) overdue. By way of example, if the risk value is above a mapped threshold value, the open invoice may be labeled as having a high risk, in which more aggressive actions may be recommended (e.g., sending the notification recommending the payment plan). In another example, if the risk value is below the mapped threshold value, the open invoice may be labeled as having a low risk, in which less aggressive actions (e.g., sending the reminder) may be recommended, or even no action may be done. By doing so, the payer of low-risk invoices may experience less annoyance, and the payee (e.g., a business) of the invoice may better allocate its resources in collecting the accounts receivable.

Consistent with some embodiments of this disclosure, the invoice data may be associated with a plurality of open invoices under different accounts. In such a case, the processor of the system may determine a plurality of expected payment dates for the plurality of open invoices by inputting the invoice data to the prediction model. The processor may also determine a plurality of expected payment date ranges under the confidence level for the plurality of open invoices based on the invoice data. The processor may further determine a plurality of probabilities of receiving payments for the plurality of open invoices by the predetermined date. The processor may further determine an expected total payment to be received by the predetermined date based on the plurality of open invoices and the plurality of probabilities of receiving payments for the plurality of open invoices by the predetermined date. An expected total payment, as used herein, may refer to a total payment amount expected to be received over the plurality of open invoices. The processor may further output the plurality of expected payment dates, the plurality of expected payment date ranges under the confidence level, the plurality of probabilities of receiving the payments for the plurality of open invoices by the predetermined date, and the expected total payment to be received by the predetermined date for risk management analysis.

In some embodiments, the processor can output a first recommended action when the expected total payment is below a threshold amount by a predetermined date, and a second recommended action when the expected total payment is above the threshold amount by a predetermined date. For example, the first recommended action may include sending a recommendation for adjusting a risk or treasury management strategy given the expected total payments to be received by a predetermined date. In another example, the second recommended action for the accounts with open invoices in the plurality of the open invoices analyzed may include at least one of sending a reminder (e.g., an email, a text, a phone call, or a mobile application notification) to a holder of the account (e.g., an owner, an agent of the owner, an authorized user, an account administrator, or any individual or entity associated with operating an account) before the predetermined date, sending a notification (e.g., an email, a text, a phone call, or a mobile application notification) recommending a payment plan to the holder of the account before the predetermined date, sending a warning notification (e.g., an email, a text, a phone call, or a mobile application notification) to the holder of the account when the open invoice is not yet or marginally (e.g., within a preset days, such as five days) overdue, or sending the open invoice to a debt collection agency when the open invoice is significantly (e.g., beyond the preset days) overdue.

In some embodiments, the processor may determine the expected total payment for a business group of accounts (e.g., accounts belonging to a common division of the business or of the whole business).

For example, in accordance with Eqs. (1) to (2), if the probability distribution c is the t distribution, and if the invoice data is associated with four invoices (e.g., four pending invoices) under four accounts, the determination of the total expected payment amount from the four pending invoices may be illustrated in Table 1.

TABLE 1

| | Invoices | | | |
|---|---|---|---|---|
| Data Element | 1 | 2 | 3 | 4 |
| Invoice Date | Sep. 24, 2018 | Sep. 26, 2018 | Sep. 27, 2018 | Sep. 27, 2018 |
| Current Date | Oct. 18, 2018 | Oct. 18, 2018 | Oct. 18, 2018 | Oct. 18, 2018 |
| Invoice Amount | $90.00 | $2,692.77 | $182.47 | $9.56 |
| Predetermined Date | Nov. 17, 2018 | Nov. 17, 2018 | Nov. 17, 2018 | Nov. 17, 2018 |
| Prediction | | | | |
| Expected Payment Date | Nov. 3, 2018 | Oct. 24, 2018 | Nov. 14, 2018 | Nov. 14, 2018 |
| Estimation Error in Days | 15.3756328 | 15.3746234 | 15.3750824 | 15.3753595 |
| (CL: 95%) | | | | |
| Expected Payment Date | | | | |
| Range-Low (CL: 95%) | Oct. 4, 2018 | Sep. 26, 2018 | Oct. 15, 2018 | Oct. 15, 2018 |
| Expected Payment Date | Dec. 4, 2018 | Nov. 23, 2018 | Dec. 15, 2018 | Dec. 14, 2018 |
| Range-High (CL: 95%) | | | | |
| Left-Tailed Cumulative | | | | |
| Probability | | | | |
| P1 | 0.81872636 | 0.94073610 | 0.57735039 | 0.57734901 |
| P2 | 0.14903175 | 0.34817552 | 0.03954020 | 0.03954291 |
| P3 | 0.66969460 | 0.59256058 | 0.53781018 | 0.53780610 |
| P4 | 0.85096824 | 0.65182447 | 0.96045979 | 0.96045709 |
| P5 | 0.78697955 | 0.90907998 | 0.55995075 | 0.55994808 |
| Expected Total Payment | | | | |
| A_{P5} | $70.83 | $2,447.94 | $102.17 | $5.35 |

Table 1 includes four data categories: the “data element,” the “prediction,” the “left-tailed cumulative probability,” and the “expected total payment,” all of which will be detailed in the following description. In some embodiments, the data in the “prediction” category may be determined at a time when invoices are opened. In some embodiments, the data in the “left-tailed cumulative probability” category and the “expected total payment” category may be determined at the time when invoices are opened or any time thereafter as long as the invoices remain open.

In Table 1, the dates are all in a format of “month/date/year.” As illustrated in Table 1, there are four invoices (numbered as 1, 2, 3, and 4). The processor may use multiple data elements (e.g., an invoice date, the date of observation, an invoice amount, the predetermined date, the expected payment date, a standard error of forecast of the expected payment date, or any combination thereof) in each invoice for determining the predictions. The lower and upper bound dates under a confidence level (e.g., 95%) can be provided as references. In Table 1, the row “Expected Payment Date Range—Low (CL: 95%)” represents the lower bound (e.g., the soonest date) of the expected payment date range under the confidence level 95%, and the row “Expected Payment Date Range—High (CL: 95%)” represents the higher bound (e.g., the latest date) of the expected payment date range under the confidence level 95%. For example, the date of observation may be “today.” The predetermined date may be determined by the payee of the invoices. For example, the predetermined date may be a payee-selected date that has been set as a target for an invoice collector to maximize payment from an open account receivable over the next 30 days. In another example, the predetermined date may be a payee-selected due date for the invoices. As illustrated in Table 1, the predetermined dates are the same for the four invoices, which are 30 days after the current date.

Consistent with the illustration of Table 1, four t-statistic variables T may be constructed as Eq. (3):

$$T = \frac{A - B}{S} \qquad Eq . ( 3 )$$

where A represents a predetermined date (e.g., Nov. 17, 2018), B represents an expected payment date (e.g., Nov. 3, 2018 for invoice 1), and S represents an estimation error (e.g., 15.3756328 for invoice 1). T conforms with a normalized t distribution (e.g., with a mean of 0). Using T, five cumulative probabilities, P1 to P5, may be determined as follows.

In Table 1, P1 represents a probability that the invoice will be paid between a date when the invoice is opened (an “open date”) and the predetermined date, conditioned on the expected payment date. P2 represents a probability that the invoice would have been paid between the open date and the date of observation, conditioned on the expected payment date. P3 represents a probability, given the invoice is not paid between the open date and today, that the invoice will be paid between today and the predetermined date, conditioned on the expected payment date. For example, P3 may be determined as P1 minus P2 (i.e., P3=P1−P2). P4 represents a probability that the invoice will receive a payment any time after the current date, conditioned on the expected payment date. For example, P4 may be determined as one minus P2 (i.e., P4=1−P2). P5 represents a probability that the invoice will receive a payment between the current date and the predetermined date conditioned on that no payment is received as of the date of observation and on the expected payment date. For example, P5 may be determined as P3 divided by P4 (i.e., P5=P3/P4).

Based on P5, the expected payment amount between the current date and the predetermined date, represented as A_{P5} in Table 1, may be determined as P5 times the invoice amount (i.e., A_{P5}=P5*Invoice Amount). The processor may then determine the total expected payment amount from the four pending invoices between the current date and the predetermined date by adding up the four A_{P5}.

It should be noted that, the t distribution used in the calculation of Table 1 may also be replaced with a normal distribution (i.e., Gaussian distribution), such as in a case where the number of observations in a training sample of the machine learning technique used for developing the algorithm are large (e.g., 1000 or beyond). In some embodiments, the invoices included for determining the expected payment amount over a plurality of open invoices can be greater than 100. It should also be noted that the invoices included for training the machine learning model may be any combination of any number of pending invoices or paid invoices.

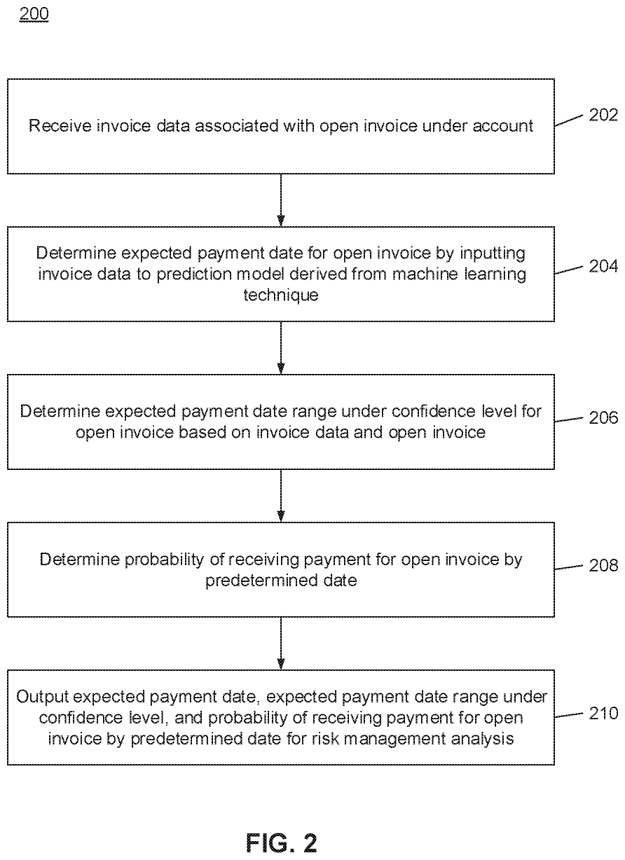

By way of example, FIG. 2 is a flowchart of example process 200 for confidence interval transaction settlement range predictions using a system (e.g., server 100) of FIG. 1, consistent with the disclosed embodiments. The system may include a memory (e.g., memory 130) that stores instructions and a processor (e.g., processor 110) programmed to execute the instructions to implement process 200. For example, process 200 may be implemented as one or more software modules (e.g., an API in risk and cash collection analyzer 112) stored in memory 130 and executable by processor 110.

Referring to FIG. 2, at step 202, the processor may receive invoice data (e.g., observations that include one or more data elements) associated with an open invoice under an account. The invoice data may include an amount of a past invoice under the account, an open date of the past invoice, a payment date of the past invoice, a count of closed invoices under the account, an average days to pay of the closed invoices, a count of overdue invoices under the account, and an average overdue days of the overdue invoices. In some embodiments, the invoice data may further include a count of pending invoices in a past period under the account, a count of past payments to the account, and a count of disputed invoices under the account.

At step 204, the processor may determine (e.g., using first prediction module 114 in FIG. 1) an expected payment date for the open invoice by inputting the invoice data to a prediction model derived from a machine learning technique. In some embodiments, the machine learning technique may include at least one of a generalized least squares regression technique, an ordinary least squares regression technique, a random forest regression technique, a gradient boosting regression technique, or a support vector machine regression technique.

At step 206, the processor may determine (e.g., using second prediction module 116 in FIG. 1) an expected payment date range under a confidence level (e.g., 95%, 90%, or any numerical percentage value) for the open invoice based on the invoice data and the open invoice.

At step 208, the processor may determine (e.g., using risk and cash collection analyzer 112 in FIG. 1) a probability of receiving a payment for the open invoice by a predetermined date (e.g., a due date set by a payee of the open invoice).

At step 210, the processor may output the expected payment date, the expected payment date range under the confidence level, and the probability of receiving the payment for the open invoice by the predetermined date for risk management analysis. In some embodiments, the processor may output the expected payment date, the expected payment date range under the confidence level, and the probability of receiving the payment for the open invoice by the predetermined date as a byte stream, and may send the byte stream into an application programming interface for the risk management analysis.

In some embodiments, the processor may determine a risk value of the open invoice based on the expected payment date, the expected payment date range under the confidence level, and the probability of receiving the payment for the open invoice by the predetermined date, and may output a recommended action if the risk value is above a threshold value. For example, the recommended action may include at least one of sending a reminder to a holder of the account before the predetermined date, sending a notification recommending a payment plan to the holder of the account before the predetermined date, sending a warning notification to the holder of the account if the open invoice is not yet or only marginally overdue, or sending the open invoice to a debt collection agency if the open invoice is significantly overdue.

Consistent with some embodiments of this disclosure, the invoice data may be associated with a plurality of open invoices under different accounts. In such a case, the processor of the system may determine a plurality of expected payment dates for the plurality of open invoices by inputting the invoice data to the prediction model. The processor may also determine a plurality of expected payment date ranges under the confidence level for the plurality of open invoices based on the invoice data. The processor may further determine a plurality of probabilities of receiving payments for the plurality of open invoices by the predetermined date. The processor may further determine an expected total payment to be received by the predetermined date based on the plurality of open invoices and the plurality of probabilities of receiving payments for the plurality of open invoices by the predetermined date. The processor may further output the plurality of expected payment dates, the plurality of expected payment date ranges under the confidence level, the plurality of probabilities of receiving the payments for the plurality of open invoices by the predetermined date, and the expected total payment to be received by the predetermined date for risk management analysis.

A non-transitory computer-readable medium may be provided that stores instructions for a processor (e.g., processor 110) for confidence interval transaction settlement range predictions in accordance with the example flowcharts of FIG. 2 above, consistent with embodiments in the present disclosure. For example, the instructions stored in the non-transitory computer-readable medium may be executed by the processor for performing process 200 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system comprising:
a non-transitory computer-readable medium configured to store instructions; and
at least one processor configured to execute the instructions to perform operations comprising:
receiving invoice data associated with an open invoice under an account, the invoice data comprising:
at least one of an amount of a past invoice under the account, an open date of the past invoice, or a payment date of the past invoice, and
at least one of: a count of closed invoices under the account, an average days to pay of the closed invoices, a count of overdue invoices under the account, or an average overdue days of the overdue invoices;
determining an expected payment date for the open invoice by inputting the invoice data to a prediction model derived from a machine learning technique;
determining an expected payment date range under a confidence level for the open invoice based on the invoice data and the open invoice, the confidence level being a statistical estimate representing a probability that an actual payment date falls in the expected payment date range;
determining a probability of receiving a payment for the open invoice by a predetermined date; and
outputting the expected payment date, the expected payment date range under the confidence level, and the probability of receiving the payment for the open invoice by the predetermined date for risk management analysis.

2. The system of claim 1, wherein the invoice data further comprises a count of pending invoice in a current or past period under the account, a count of past payments to the account, and a count of disputed invoices under the account.

3. The system of claim 1, wherein the machine learning technique comprises at least one of a generalized least squares regression technique, an ordinary least squares regression technique, a random forest regression technique, a gradient boosting regression technique, or a support vector machine regression technique.

4. The system of claim 1, wherein outputting the expected payment date, the expected payment date range under the confidence level, and the probability of receiving the payment for the open invoice by the predetermined date comprises:
outputting the expected payment date, the expected payment date range under the confidence level, and the probability of receiving the payment for the open invoice by the predetermined date as a byte stream; and
sending the byte stream into an application programming interface for the risk management analysis.

5. The system of claim 1, wherein the operations further comprise:
determining a risk value of the open invoice based on the expected payment date, the expected payment date range under the confidence level, and the probability of receiving the payment for the open invoice by the predetermined date; and
outputting a recommended action when the risk value is above a threshold value.

6. The system of claim 5, wherein the recommended action comprises at least one of sending a reminder to a holder of the account before the predetermined date, sending a notification recommending a payment plan to the holder of the account before the predetermined date, sending a warning notification to the holder of the account when the open invoice is marginally overdue, or sending the open invoice to a debt collection agency when the open invoice is significantly overdue.

7. The system of claim 1, wherein the invoice data is associated with a plurality of open invoices under different accounts, and the operations further comprise:
determining a plurality of expected payment dates for the plurality of open invoices by inputting the invoice data to the prediction model;
determining a plurality of expected payment date ranges under the confidence level for the plurality of open invoices based on the invoice data;
determining a plurality of probabilities of receiving payments for the plurality of open invoices by the predetermined date;
determining an expected total payment to be received by the predetermined date based on the plurality of open invoices and the plurality of probabilities of receiving payments for the plurality of open invoices by the predetermined date; and
outputting the plurality of expected payment dates, the plurality of expected payment date ranges under the confidence level, the plurality of probabilities of receiving the payments for the plurality of open invoices by the predetermined date, and the expected total payment to be received by the predetermined date for the risk management analysis.

8. The system of claim 7, wherein the operations further comprise:
outputting a first recommended action when the expected total payment is below a threshold amount, and a second recommended action when the expected total payment is above the threshold amount.

9. A computer-implemented method comprising:
receiving invoice data associated with an open invoice under an account, the data comprising:
at least one of an amount of a past invoice under the account, an open date of the past invoice, or a payment date of the past invoice, and
at least one of: a count of closed invoices under the account, an average days to pay of the closed invoices, a count of overdue invoices under the account, or an average overdue days of the overdue invoices;
determining an expected payment date for the open invoice by inputting the data to a prediction model derived from a machine learning technique;
determining an expected payment date range under a confidence level for the open invoice based on the data and the open invoice, the confidence level being a statistical estimate representing a probability that an actual payment date falls in the expected payment date range;
determining a probability of receiving a payment for the open invoice by a predetermined date; and
outputting the expected payment date, the expected payment date range under the confidence level, and the probability of receiving the payment for the open invoice by the predetermined date for risk management analysis.

10. The computer-implemented method of claim 9, wherein the invoice data further comprises a count of pending invoice in a current or past period under the account, a count of past payments to the account, and a count of disputed invoices under the account.

11. The computer-implemented method of claim 9, wherein the machine learning technique comprises at least one of a generalized least squares regression technique, an ordinary least squares regression technique, a random forest regression technique, a gradient boosting regression technique, or a support vector machine regression technique.

12. The computer-implemented method of claim 9, wherein outputting the expected payment date, the expected payment date range under the confidence level, and the probability of receiving the payment for the open invoice by the predetermined date comprises:
outputting the expected payment date, the expected payment date range under the confidence level, and the probability of receiving the payment for the open invoice by the predetermined date as a byte stream; and
sending the byte stream into an application programming interface for the risk management analysis.

13. The computer-implemented method of claim 9, further comprising:
determining a risk value of the open invoice based on the expected payment date, the expected payment date range under the confidence level, and the probability of receiving the payment for the open invoice by the predetermined date; and
outputting a recommended action if the risk value is above a threshold value.

14. The computer-implemented method of claim 9, wherein the invoice data is associated with a plurality of open invoices under different accounts, and the computer-implemented method further comprises:
determining a plurality of expected payment dates for the plurality of open invoices by inputting the data to the prediction model;
determining a plurality of expected payment date ranges under the confidence level for the plurality of open invoices based on the data;
determining a plurality of probabilities of receiving payments for the plurality of open invoices by the predetermined date;
determining an expected total payment to be received by the predetermined date based on the plurality of open invoices and the plurality of probabilities of receiving payments for the plurality of open invoices by the predetermined date; and
outputting the plurality of expected payment dates, the plurality of expected payment date ranges under the confidence level, the plurality of probabilities of receiving the payments for the plurality of open invoices by the predetermined date, and the expected total payment to be received by the predetermined date for the risk management analysis.

15. The computer-implemented method of claim 14, further comprising:
outputting a first recommended action when the expected total payment is below a threshold amount, and a second recommended action when the expected total payment is above the threshold amount.

16. A non-transitory computer-readable medium storing a set of instructions that is executable by at least one processor of an apparatus to cause the apparatus to perform a method, the method comprising:
receiving invoice data associated with an open invoice under an account, the data comprising:
at least one of an amount of a past invoice under the account, an open date of the past invoice, or a payment date of the past invoice, and
at least one of: a count of closed invoices under the account, an average days to pay of the closed invoices, a count of overdue invoices under the account, or an average overdue days of the overdue invoices;
determining an expected payment date for the open invoice by inputting the data to a prediction model derived from a machine learning technique;
determining an expected payment date range under a confidence level for the open invoice based on the data and the open invoice, the confidence level being a statistical estimate representing a probability that an actual payment date falls in the expected payment date range;
determining a probability of receiving a payment for the open invoice by a predetermined date; and
outputting the expected payment date, the expected payment date range under the confidence level, and the probability of receiving the payment for the open invoice by the predetermined date for risk management analysis.

17. The non-transitory computer-readable medium of claim 16, wherein the invoice data further comprises a count of pending invoice in a current or past period under the account, a count of past payments to the account, and a count of disputed invoices under the account, and
the machine learning technique comprises at least one of a generalized least squares regression technique, an ordinary least squares regression technique, a random forest regression technique, a gradient boosting regression technique, or a support vector machine regression technique.

18. The non-transitory computer-readable medium of claim 16, wherein outputting the expected payment date, the expected payment date range under the confidence level, and the probability of receiving the payment for the open invoice by the predetermined date comprises:
outputting the expected payment date, the expected payment date range under the confidence level, and the probability of receiving the payment for the open invoice by the predetermined date as a byte stream; and
sending the byte stream into an application programming interface for the risk management analysis.

19. The non-transitory computer-readable medium of claim 16, wherein the method further comprises:
determining a risk value of the open invoice based on the expected payment date, the expected payment date range under the confidence level, and the probability of receiving the payment for the open invoice by the predetermined date; and
outputting a recommended action if the risk value is above a threshold value.

20. The non-transitory computer-readable medium of claim 16, wherein the invoice data is associated with a plurality of open invoices under different accounts, and the method further comprises:
determining a plurality of expected payment dates for the plurality of open invoices by inputting the data to the prediction model;
determining a plurality of expected payment date ranges under the confidence level for the plurality of open invoices based on the data;
determining a plurality of probabilities of receiving payments for the plurality of open invoices by the predetermined date;
determining an expected total payment to be received by the predetermined date based on the plurality of open invoices and the plurality of probabilities of receiving payments for the plurality of open invoices by the predetermined date; and
outputting the plurality of expected payment dates, the plurality of expected payment date ranges under the confidence level, the plurality of probabilities of receiving the payments for the plurality of open invoices by the predetermined date, and the expected total payment to be received by the predetermined date for the risk management analysis.
